(19) United States
(12) Patent Application Publication
(10) Pub. No.: US 2016/0092094 A1
(43) Pub. Date: Mar. 31, 2016

(54) USER INTERFACE FOR ORGANIZING TASKS AND ACTIVITIES ON A COMPUTING DEVICE

(71) Applicant: Artimagination, Inc., Ojai, CA (US)

(72) Inventors: Jay Edward Topping, Ojai, CA (US); Margot Nicole van Dam, Ojai, CA (US)

(73) Assignee: Artimagination, Inc.

(21) Appl. No.: 14/871,770

(22) Filed: Sep. 30, 2015

Related U.S. Application Data
(60) Provisional application No. 62/057,878, filed on Sep. 30, 2014.

(51) Int. Cl. G06F 3/0484; G06F 3/0482

(52) U.S. Cl. CPC G06F 3/04847; G06F 3/0482; G06F 3/04842

(57) ABSTRACT

A system and method is provided for the effective accomplishment of objectives (aka goals or quests) through information and motivational support and through the organization of user-editable records. The described application provides information content and motivational support and associates disparate data entry types (including but not limited to expense items, income items, audio items, video items, photo items, note items, calendar/event items and contact items) to specific tasks while associating disparate tasks to user identified goals. This system and method enables a user (A) to manage (i) objectives (aka goals or quests), (ii) tasks leading to a goal, and (iii) data associated with each task, and (B) to obtain information content and motivational support.

### RELATED APPLICATIONS

This application claims priority to U.S. Provisional Patent Application No. 62/057,878, filed Sep. 30, 2014, entitled USER INTERFACE FOR ORGANIZING TASKS AND ACTIVITIES ON A COMPUTING DEVICE; the aforementioned priority application being hereby incorporated by reference in its entirety.

### TECHNICAL FIELD

Examples described herein relate to a user interface for accomplishing objectives through information, support and task organization.

### BACKGROUND

There are numerous project management applications which enable users to manage and organize activities. In particular, computing devices enable users to enter activity data, enter their own progress on their activities, and record their completion.

### BRIEF DESCRIPTION OF THE DRAWINGS

FIG. 1 illustrates an example system for organizing information, according to an embodiment.

FIG. 2 illustrates a computing device for organizing activity information, according to an embodiment.

FIG. 3 illustrates an example method for providing interfaces to receive and display activity information, according to an embodiment.

FIG. 4A-4B illustrate example screenshots of interfaces, according to embodiments.

FIG. 5 illustrates an example data structure for storing activity-related information, according to an embodiment.

FIG. 6 illustrates an example method in which a user develops and updates one or more quest records, according to an embodiment.

### DETAILED DESCRIPTION

Examples described herein provide for a system, device and method for organizing activities of a user. Among other benefits, examples such as described herein enable user activity information to be stored, managed and provided in manners which clearly communicate relationships and categories of information.

Among other benefits, examples as described provide information content and motivational support and associates disparate data entry types (including but not limited to expense/purchase items, income/sale items, audio items, video items, photo items, note items, calendar items and contact items) to specific tasks while associating disparate tasks to user identified goals.

According to an embodiment, an application is structured to execute on a computer and to provide the user with guidance and prompts for entering information about activities, and specifically information that is categorized as a quest, task or action. The relationship as between quest, task and action can be facilitated with relationship data and triggers which enable the user to organize and complete tasks and activities.

In contrast to limitations of conventional approaches, examples enable a computing device to include a user interface that (A) combines both information support and emotional motivational support with goal achievement; and (B) which allows for the goal data to be divided into tasks; and (C) with data entry types encompassing all and any of income/sale type data, expense/purchase type data, audio type data, video type data, photograph type data, event type data, contact type data and note type data; and (D) with both the goals and tasks respectively being capable of being infinitely reorganized. The features (A) through (D) can further be inclusively and efficiently housed under one application executing on a user computing device.

In an embodiment, a user interface is provided to include a selectable interface element to enable creation, modification and deletion of records. The selectable interface element is positioned on the user interface to visually indicate a relationship between activities that can be created by the user. For example, the selectable interface element is provided in-line and/or in close proximity to a description or header for a record. When selected, the user is enabled to perform an interaction with the associated record.

In an embodiment, a program operates on a computing device to provide interfaces to receive, modify and store different kinds of activity-related kinds of information supplied by a user. In particular, the program receives different pieces of information related to different levels of detail, and relates this information to each other. For example, the program may receive information for an overall goal (e.g. “quest”), steps relating to the goal (e.g. “tasks”) and further elements of the steps (“actions” or “entries”). The program then relates these pieces of information to each other. As used herein, (i) a quest is an objective that can be achieved through accomplishment of one or more tasks (sub-objectives); (ii) tasks are objectives that are associated and linked to quests, and which are necessary to complete the quest; and (iii) “Actions” or “entries” are sub-objectives which are associated and linked to a task, and which are necessary to complete in order to achieve the task.

In one implementation, a computing device operates to receive a first user input that defines a first task. The computing device enables the user to create a plurality of entries associated with the first task, each of the plurality of entries specifying an action record that has a type selected from a group of types that includes, but are not limited to, a contact type and a calendar type. The computing device displays a heading for the first task that is in-line with an active interface feature. Upon selection of the active interface feature, the computing device performs at least one of: (A) providing, with the interface, one or more editing features to enable the user to (i) create a new entry and select a type for the new entry, (ii) edit an existing entry, and/or (iii) delete and existing entry; and/or (B) displaying an interface that includes the plurality of entries of all types associated with each task for a particular objective, with each entry's type identified by both color code and name, date of record and summary of activity; and/or (C) display an interface that includes the plurality of entries of a particular type regardless of the associated objective and task (such as all expense type entries displayed together in order of date incurred, or such as all calendar type entries displayed together in both date order and color coded format to indicate the nearness to the current date of such calendar type entry), in each case with the user further enabled to see, for each entry so displayed, the particular objective and task associated with each such entry; and/or (D) providing, with the interface, one or more features to enable the user to edit, re-order, or create an objective (goal); and/or (E) providing, with the interface, one or more features to enable the user to edit or create a new task associated with an existing objective. Editing, deletion and re-ordering of tasks can also be provided.

A first user input is received that defines a first objective. A heading is then displayed for the first objective (aka goal or quest). A plurality of objectives may be entered and managed, edited, deleted, and re-ordered. A user may then create a plurality of tasks associated with that objective.

Additionally, a second user input can be received that defines a first task associated with that first objective. A heading can also be displayed for the first task. A plurality of tasks associated with a goal can be entered and managed, edited, deleted, and re-ordered.

In some variations, a user can create a plurality of entries associated with this first task, each of the plurality of entries specifying an action record that has a type selected from a group of types that include an income/sale type, an expense/purchase type, a contact type, a photo type, an audio type, a video type, a calendar/event type, and a note type. A plurality of entries associated with a task can be entered and managed, edited, deleted, and re-ordered.

In some examples, upon selection of the active interface feature, at least one of the following is performed: A) providing, with the interface, one or more features to enable the user to (i) create a new entry and select a type for the new entry, (ii) edit an existing entry, and or (iii) delete an existing entry; B) display an interface that includes the plurality of entries of all types associated with each task for a particular objective, with each entry's type identified by both color code and name, date of record and summary of activity; C) display an interface that includes the plurality of entries of a particular type regardless of the associated objective and task (such as all expense type entries displayed together in order of date incurred, or such as all calendar type entries displayed together in both date order and color coded format to indicate the nearness to the current date of such calendar type entry), in each case with the user further enabled to see, for each entry so displayed, the particular objective and task associated with each such entry; D) providing, with the interface, one or more features to enable the user to edit, delete, re-order, or create an objective (aka goal or quest); and/or E) providing, with the interface, one or more features to enable the user to edit or create a new task associated with an existing objective.

According to some examples, a system and method is provided for enabling a user to receive information content and emotional or motivational support at the user's request by selecting an icon on the display. In addition, information content and emotional/motivational support are also automatically generated when a user indicates that an objective (aka goal or quest) has been completed.

In a further example, an interface is generated to receive input for a quest. After receiving data for a quest, a successive interface is generated to provide information about the quest and receive input for a task, which is a part of the overall effort required to complete the quest, and which includes a description. The description may, for example, be user provided and describe how to complete the task. Furthermore, a selectable interface element is provided to receive a selection. In response to receiving the selectable interface element, a menu is provided to enable receiving an entry about the task. The selectable interface element can be provided at a particular location. For example, the selectable interface element may be provided in-line and in at least close proximity to a description of the task, to show that the selectable interface element is associated with the task.

Examples as described herein allow for users to store task-related data, related to an overall goal. Furthermore, data may be stored which is associated with a task, such as action item data. These multiple levels enable the user to define underlying steps for tasks to be completed. Additionally, by providing an interface to receive data, and selectable item on the interface to trigger various interactions with data stored on the computing device, the user may interact with representations of the data to manipulate the underlying data. Furthermore, by positioning the selectable item in particular locations, the user can be quickly informed that the selectable item is associated with a particular task, and can help the user make an intuitive interaction with the interface to manipulate the data.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program, including but not limited to all portable and wearable devices.

System Overview

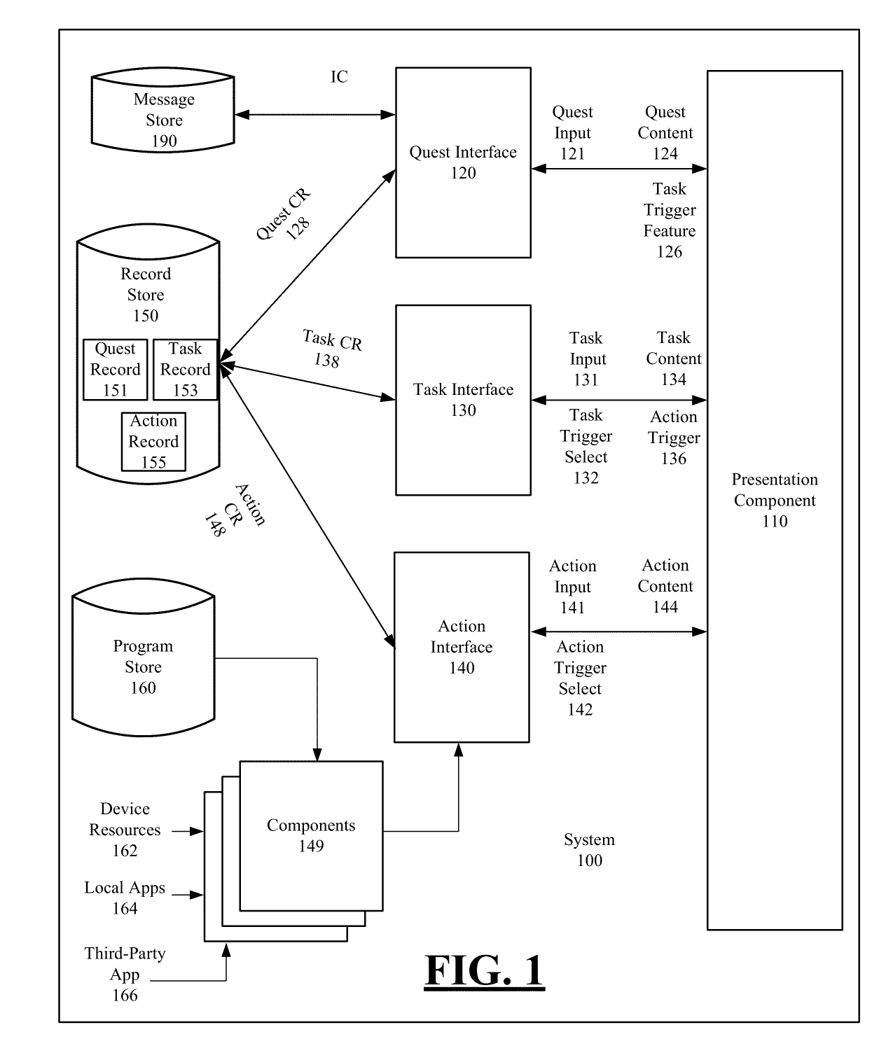

FIG. 1 illustrates an example system for organizing information, according to an embodiment. With reference to an example of FIG. 1, a system 100 can execute on a computing device as an application or combination of applications. By way of example, system 100 can be implemented as an application or combination of applications that runs on a mobile computing device (e.g., telephony and/or messaging device), tablet, laptop or desktop computer. Alternatively, system 100 can be implemented as part of an operating system for a computing device.

In an example of FIG. 1, system 100 includes presentation component 110, quest interface 120, task interface 130, and action interface 140. The components combine to store records of different types and to provide task management functionality of different kinds through a common application framework. In more detail, a quest interface 120 operates to enable creation of “quests” which provide an organization for enabling a user to specify tasks and actions. The task interface 130 operates to enable the user to specify tasks which are embedded or otherwise linked to quests, and the action interface 140 enables the creation of action items which are likewise embedded or linked to tasks and/or quests. As described in greater detail, the organizational structure created through the generation of quests, tasks, and actions can result in the generation of records that are of different types, for use with different kinds of application functionality (e.g., calendar functionality, expense functionality, etc.).

A “quest” constitutes any goal to be achieved by the user. A quest is composed of one or more “tasks” which are required to complete the quest. Each task individually identifies a goal, which may be a step required to complete the quest. Each task is further composed of one or more “actions” (“action items”) which, when completed, will achieve the task.

Still further, in some embodiments, a selectable interface feature, such as a button, is displayed in-line with descriptive content for an activity, and is linked to the activity. When the interface feature is selected, the user is provided options to create, modify or delete quests, tasks or action items for the linked activity. The user interface feature is provided on the user interface in a manner to visually associate the feature with a quest or task.

In the embodiment of FIG. 1, input is provided to various interfaces such as quest interface 120. The interfaces implement processes to cause records (alternately “container records”) corresponding to the input to be created in, modified in, or deleted from record store 150. Furthermore, the interfaces provide content corresponding to stored container records on presentation component 110. Additionally, the interfaces detect a trigger selection and provide a trigger on presentation component 110 in order to enable further use of the interfaces.

In more detail, system 100 includes presentation component 110, quest interface 120, task interface 130, action interface 140, record store 150 and program store 160. Some or all of the programmatic components shown with the computing system 100 can be provided in part as operating system-level components

In an implementation, quest interface 120 can receive quest input 121 via user interaction with content elements (e.g., icons, menus, text fields, etc.) of presentation component 110. The quest input 121 can specify the creation of a quest, modification of an existing quest, deletion of an existing quest, re-ordering of existing quests, and/or completion of an existing quest. The resulting quest or changes thereof can be recorded in the record store 150. When a quest is created, quest interface 120 signals quest create 128 to record store 150 resulting in the creation of a corresponding container record. The quest input 121 can specify descriptive information or other identifiers that can be stored with the container record. For example, the user can specify descriptive information that appears as a header of the record of the quest (“quest record”), and the header can then be stored with the container record for that quest.

The quest interface 120 can link with task trigger feature 126, which can be displayed through the presentation component 110. The presentation component 110 can display content corresponding to the trigger feature 126 in association with the header and/or descriptive content of the quest. In one implementation, the trigger feature 126 is displayed as an icon or other selectable input and is displayed in-line (e.g., in proximity, on the same row or same horizontal coordinate, etc.) with the descriptive content of the quest, so that the user's input automatically associates tasks or action items subsequently generated with the particular quest. In one implementation, when the user selects the trigger feature, a menu or other interactive feature is displayed to enable the user to create a task and to specify header or other content for the task. The use of the trigger feature provides one mechanism for the user to create a task that is automatically linked with the quest. Other mechanisms can also be used to create tasks with, for example, manual or voice input to link with the quest. The presentation component 110 can signal task creation input to the task interface 130 which in turn signals task creation 138 to the record store 150. A task record 153 can then be created for the record store 150.

In the example of FIG. 1, quest input 121 is provided from presentation component 110 to quest interface 120. In one implementation, the quest input 121 can include text input and other content (e.g., icons, pictures). The quest input 121 is used to define a specific quest record 151, including content that is to be associated with the quest record.

Still further, quest content 124 can include graphics, features and other framework content that are specific to the quest interface and its content. In an embodiment, quest content 124 includes a menu to receive descriptive content for quest input 121 from a user corresponding to a quest to be created. When the input is received and the quest is created, quest content 124 is updated to show the new quest. Quest input 121 may also include individual features to enable creation, deletion or modification of quests. For example, options may be provided in a menu.

When trigger feature 126 is selected, task trigger select 132 is signaled to task interface 130. The task interface 130 can generate or configure a form for display via the presentation component 110. The form can enable user input (e.g., text entry, selection input) to generate content for the task, including descriptive content.

In implementations, task trigger 126 is provided with content from a particular quest. When the task trigger 126 is activated, the task interface 130 automatically links a subsequent task input 131 with the quest on which the activation trigger is displayed. A feature representation of the task trigger 126 (e.g., a button), can be positioned at or near (e.g., in-line) a header or description for the quest. The feature representation can be positioned in order to provide visual identification with the quest that is to be linked with the task.

In particular, task interface 130 can receive task input 131 via user interaction with content elements (e.g., icons, menus, text fields, etc.) of presentation component 110, such as presented in task content 134. The task input 131 can specify the creation of a task, modification of an existing task, and/or deletion of an existing task. The resulting task or changes thereof can be recorded in the record store 150, as well as a linked quest. More specifically, when a task is created, task interface 130 signals task create 138 to record store 150 resulting in the creation of a corresponding container record. The task input 131 can specify descriptive information or other identifiers that can be stored with the container task record. For example, the user can specify descriptive information that appears as a header of the quest task, and the header can then be stored with the container record for that task. A user can also re-order tasks.

In some variations, task content 134 may be provided with, or replacement of, quest content 124. For example, task content 134 overlays quest content 124, maintaining at least a portion of quest content 124 on the presentation component 110. In another embodiment, quest content 124 is removed from the screen when task content 134 is displayed.

Task interface 130 causes a selectable action trigger 136 to be generated on presentation component 110. The trigger 136 can be represented iconically or graphically with the task, so as to represent that the trigger's activation generates an association between the task and the item created by the trigger. Action trigger 136 may be provided as an image (e.g., icons or graphic objects), text, or in other forms.

The presentation component 110 can display content corresponding to the action trigger 136 in association with the header and/or descriptive content of a linked task and/or quest. In an implementation, action trigger 136 is displayed as a selectable input feature (e.g., icon) which is positioned in-line with the descriptive content of a particular task. The action trigger's position visually indicates that the input associated with action trigger 136 (e.g., generate a new action item) will be associated with the particular task.

In an implementation, when the user selects action trigger 136 (thus signaling action trigger select 142 to action interface 140), an interactive feature is displayed to enable the user to create an action item. The created action item can be automatically linked to a task and quest, depending on whether action trigger 136 is also so linked. When selected, the user may provide header or content for the action item, which is then stored. Other mechanisms can be used to create actions, such as a manual command to link the action with a task and quest.

In the embodiment of FIG. 1, presentation component 110 signals action creation input 141 to the action interface 140, which then signals action creation 148 to record store 150. An action record 155 is then created based on the input.

Embodiments provide for action input 141 to be provided in various forms, such as text input, selections of elements provided on presentation component 110 (e.g., icons, pictures, buttons, etc.), menu selections, or combinations thereof. In an example, text is provided through a user-fillable form provided on presentation component 110, identifying an action to be created. Action interface 140 receives the text as the action input 141.

In addition, action interface 140 enables other functions such as modification, re-ordering, and deletion of action records. For example, in response to a command (e.g. via action input 141) to delete action record 155, action interface 140 operates to remove the action record 155 from record store 150.

The action record 155 can be of different types. For example, actions may have the types of “note,” “event/date,” “contact,” “income/sale,” “expense/purchase,” or “photo/video/audio,” as well as other different types. The type for the selected action record can be determined by, for example, tags or data associated with the action record 155. In some variations, the action record 155 can have its type determined by a data format of the record. The user input that creates the action record 155 can also specify content and other parameters which are stored as part of the record.

Embodiments further provide for distinguishing features to be provided to delineate the type of the action. To such an end, some or all of the header data for the actions may be color-coded to show the type of the action. For example, header (e.g. an icon) for an event/date record could be colored fuchsia, while header for a contact record could be colored orange.

Components 149 include different programmatic resources which are individually implemented through system 100. In an implementation of FIG. 1, each of the components 149 are triggerable to access and/or display content corresponding to records from the record store 150. Instructions for running each of the components 149 can be stored in the program store 160. The program store 160 can provide an extensible mechanism for adding or modifying output and using functionality in connection with the various records that are generated through the interfaces. The program store 160 can also carry instructions that are received from third-party sources 166.

In one implementation, the components 149 represent in-application programs that provide different kinds of functionality associated with a corresponding type of action records 155 (e.g., contact program for contact records, calendar program for calendar records, expense program for expense records). In a variation, individual components include or correspond to interfaces to other applications operating on the same device or computing environment (e.g., interface to a third-party calendar application). Still further, the individual components include or correspond to interfaces to remote services and applications (e.g., online expense service). The interfaces can utilize action records 155 of a specific type in rendering corresponding record content to a user.

The components 149 can be launched by user input and/or through interaction with actions. In an example, one or more components 149 are triggered by input provided through the action content 144. When triggered, the components 149 retrieve and display content based on the action records 155. Each component 149 can be associated with action records of a particular type, and the component 149 can retrieve or render records of the associated type. For example, a user creates a calendar action 155. During operation, a calendar component 149 triggers to retrieve calendar content (e.g., a list of dates) based on the calendar action 155. Calendar component 149 then renders the calendar content on presentation component 110.

In a variation, a user creates contact action 155. A contact component 149 triggers to interface with a third-party contact application. Contact component 149 retrieves contact content (based on the contact action 155) from the third-party contact application, and renders the contact content.

While the embodiment of FIG. 1 illustrates action interface 140 communicating with components 149, embodiments further provide for action interface 140 to directly contact resources such as device resources 162, local apps 164 and third-party apps 166. In such embodiments any data may be passed directly to action interface 140 without using components 149.

While an example of FIG. 1 depicts a 3 level task management system, other examples can utilize an n-level system. For example, a quest can correspond to a user's goal to lose weight. The user can then assign tasks, such as “go shopping”, “make healthy meal” etc., and under each task there may be one or more actions. For example, the user can put a grocery list under a “go shopping” task, with each item corresponding to acquiring an item. While shopping, however, the user can see a recipe under an item, and the user can generate a sub-shopping list under the specific item in order to obtain the ingredients for the specific recipe. For example, tasks and action data entries can be archived upon quest completion.

Application Generated Messages for User Viewing

Embodiments provide for both emotional support and informative content to be rendered to the user in response to a trigger. By way of example, the content can be inspiration messages that render when the user completes a task or quest or upon the users selecting an icon. The informational and emotional support content is retrieved from message store 190 and presented on presentation component 110. In the example of FIG. 1, the quest interface 120 can trigger and retrieve informational content and emotional support (e.g., inspirational messages) in response to a trigger such as the completion of a quest or upon the users selecting an icon. Examples of information content include images, audio, video, text and/or a combination of both audio/visual material/images and text. By way of example, the information content can be inspirational, to positively motivate a viewer. Representative triggers include quest, task or action related events (e.g., completion of a quest), as well as user-input related events (e.g., a user selection of a feature provided on the presentation component).

In one embodiment, items of inspirational content are stored in message store 190. A user completes a quest; in response to determining that the quest is completed, an item of inspirational content is retrieved from message store 190 and rendered on presentation component 110. In another embodiment, a user requests inspirational content through a feature provided on presentation component 110. Inspirational content is retrieved from message store 190 and rendered on presentation component 110.

The retrieved inspirational content may be selected from the message store 190 in various manners (e.g., randomly, user-selected, or based on one or more features associated with the inspirational content). For example, the selection may be made based on the determination that the inspirational content and the quest have common technical features (e.g., a shared tag, metadata, etc.).

Hardware Diagram

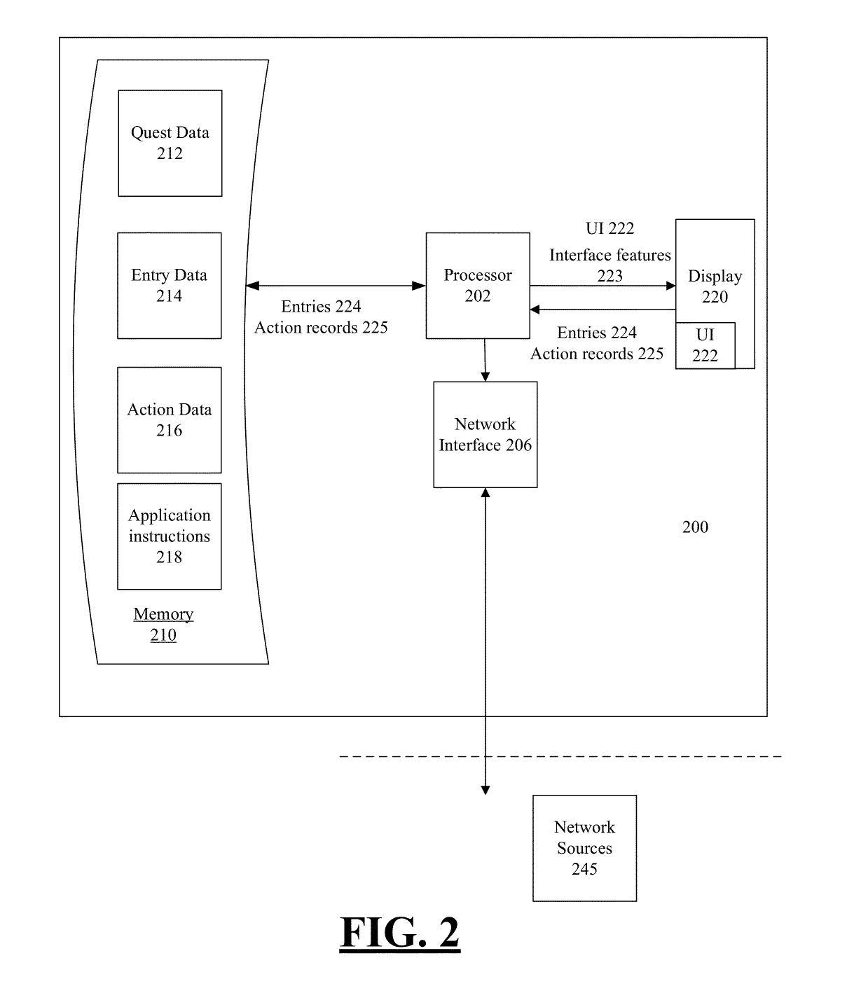

FIG. 2 illustrates a computing device for organizing activity information, according to an embodiment. In an example of FIG. 2, a device 200 corresponds to the computing device shown in FIG. 1.

FIG. 2 illustrates a device 200 having a processor 202. The processor 202 can implement functionality using instructions stored in the memory 210, such as application instructions 218. In some implementations, as part of providing functionality the processor 202 accesses other applications on device 200 or utilizes the network interface 206 to communicate with network sources 245. In an example, with reference to FIG. 1, processor 202 operates under application instructions 218 to implement functionality corresponding to component 149 (e.g., to interface with a third-party application to retrieve content). In another example, with further reference to FIG. 1, processor 202 accesses application instructions to perform the functionality of quest interface 120, task interface 130, and action interface 140.

Processor 202 renders user interface 222 (UI 222) and interface features 223 on display 220. In an embodiment, with reference to FIG. 1, UI 222 and interface features 223 correspond to presentation component 110. With further reference to FIG. 1, interface features 223 may comprise features for quest content 124, task content 134, action content 144, task trigger 126, and action trigger 136.

In some implementations, the display 220 can be touch-sensitive. For example, the display 220 can be integrated with a sensor layer that is comprised of capacitive touch sensors which trigger with contact to human skin. Alternatively, the display 220 can include alternative sensor layers, such as resistive sensors which can detect applied pressure from, for example, a human finger or stylus.

The processor 202 can receive input from various sources, including from input mechanisms (e.g., buttons or switches, microphone, keyboard), the display 220 (e.g., soft buttons or virtual keyboard) or other input mechanisms (accessory devices). In one implementation, the processor 202 can process multi-touch input detected by the sensor layer provided on the display 220.

Quest data 212, entry data 214, and action data 216 provide storage for container records associated with quests, tasks and actions. Each record is associated with a header and/or descriptive content stored in memory 210. In the embodiment shown by FIG. 2, quest records are stored in quest data 212 of the memory 210; task records are stored in entry data 214; and action records are stored in action data 216, and memory can be hard disk, flash, external media, cloud, etc.

As illustrated in FIG. 2, entries 224 and action records 225 are passed between memory 210 and processor 202. During operation, processor 202 renders records 225 on display 220, based on the content of the record (including any header and/or descriptive content associated with the record) as well as the UI 222 and interface elements 223. For example, while a calendar UI 222 is being rendered on display 220, the processor receives a request to render an action record. The processor renders the action record as part of UI 222 according to date-related header associated with the action record.

Processor 202 provides interface features 223 on display 220, including features for task trigger feature 126 and action trigger feature 136 such as described regarding FIG. 1. In one implementation, an interface feature 223 corresponding to a task trigger 126 is displayed as an icon or other selectable input and is displayed in-line with descriptive content of a quest, so that the user's input associated with the interface feature 223 automatically associates subsequently generated tasks or action items with the particular quest. Embodiments provide for multiple selectable interface features to be provided on UI 222 at a time.

As described regarding FIG. 1, information (e.g., inspirational) messages may be provided to a user. To generate these messages, the processor 202 may implement a message generator to select and provide inspirational messages. In an implementation the message generator comprises functionality to generate an inspirational message in response to detecting completion of a quest.

### Example Interfaces

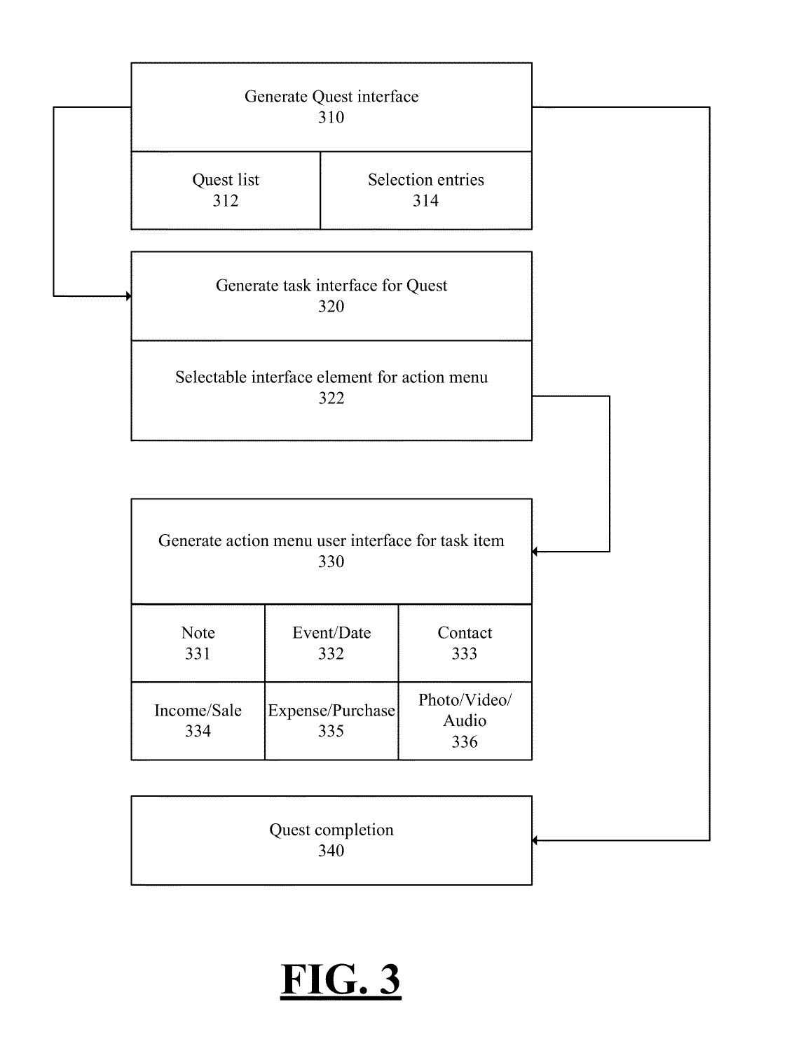

FIG. 3 illustrates an example method for providing interfaces to receive and display activity information, according to an embodiment. An example such as described by FIG. 3 can be implemented using components such as described with FIG. 1 or FIG. 2. Accordingly, reference may be made to elements of other figures for purpose of illustrating suitable elements or components for performing a step or sub-step being described.

With reference to FIG. 3, a quest interface (310) is generated on a display of a computing device (310) for a particular quest. Suitable computing devices include the computing devices described with regards to FIGS. 1 and 2. In the example of FIG. 3, a quest interface (312) is generated to include a list of stored quests (312) and one or more selection entries (314). With reference to FIG. 1, a selection entry may correspond to task trigger 126.

In a variation of FIG. 3, each selection entry is associated with a different type of operation to be taken on stored records when selected. For example, when a quest sorting selection entry is selected, a list of quests is sorted and displayed. The functionality to enact the operation may be provided by one or more components of FIG. 1 and FIG. 2. An icon representing each selection entry may be provided as part of a selection bar.

A task interface is then generated (320). In an example, the task interface is generated (320) in response to the occurrence of a condition (e.g., a user's selection of a selection entry). The task interface displays a list of stored task records associated with the quest, any stored action records associated with the stored tasks, and any elements needed to enable functionality associated with the task interface.

The task interface enables operations to be taken with regards to task records. For example, task records can be added, removed, edited, or reordered. The functionality to enact the action may be provided by one or more components of FIG. 1 and FIG. 2.

In the example of FIG. 3, the task interface is generated to include a selectable interface element for an action menu (322). With reference to FIG. 1, the selectable interface element may correspond to action trigger 136.

An action menu user interface is then generated (330) (e.g., with reference to FIG. 1, in response to an activation of the selectable interface element corresponding to action trigger select 142). The action menu user interface may correspond to the action menu 140 of FIG. 1.

The action menu user interface enables creation of different kinds of action records. For example, among other kinds of records, the action menu user interface may enable creation of notes (331), event/dates (332), contacts (333), income/sales (334), expenses/purchases (335), or media such as photo/video/audio (336). These records may be stored and used as described, for example as regarding the embodiments of FIG. 1 and

After completion of the quest, a determination is made that the quest is complete (340). As described regarding FIGS. 1 and 2, an inspirational message may be provided upon determining that the quest is complete. The quest is then archived where it may be reactivated.

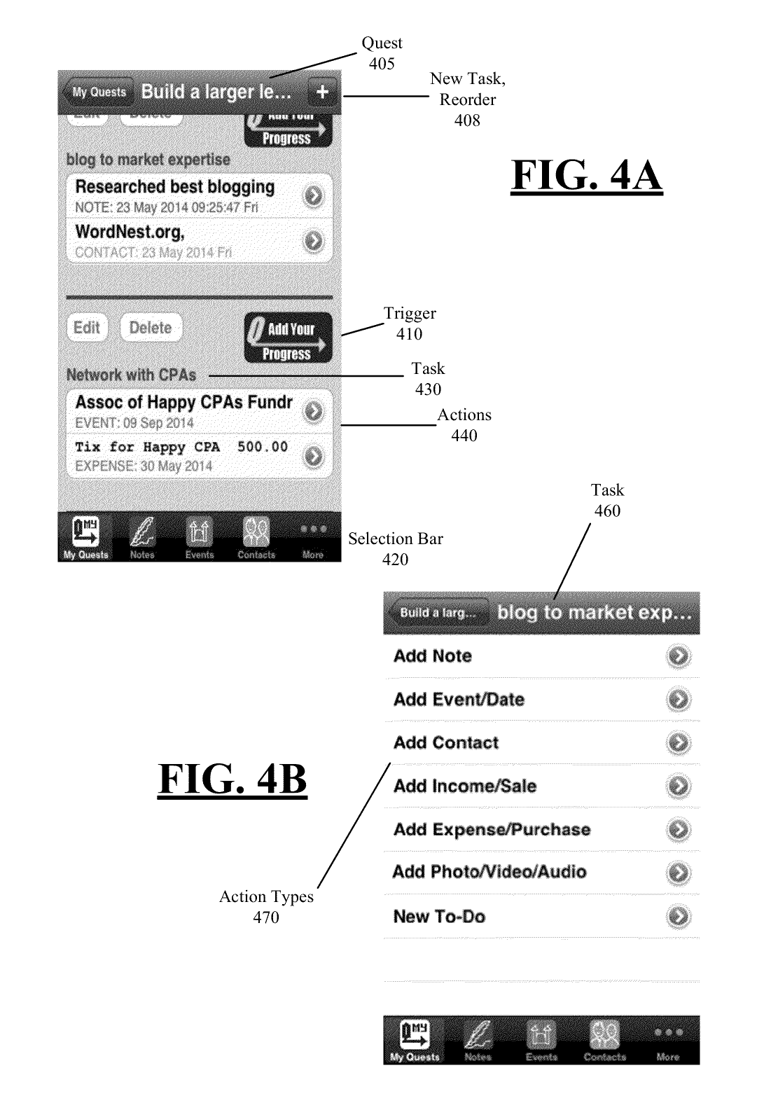

FIG. 4A-4B illustrate example screenshots of interfaces, according to embodiments. With reference to FIGS. 1 and 2, in the embodiment of FIG. 4A a selectable action trigger 410 is provided as part of the interface. When selected, trigger 410 provides the menu shown in FIG. 4B to appear. FIG. 4A includes selection bar 420, for accessing components as described regarding FIGS. 1 and 2. Furthermore FIG. 4A illustrates various tasks 430 (e.g. “blog to market expertise,” and “network with CPAs”) which are associated with an overlying quest 405 “Build a larger legal firm,” and actions 440 which are associated with the tasks (e.g. “Assoc of Happy CPAs Fundr” and “Tix for Happy CPA” which are associated with “Network with CPAs”). The content provided on the displays can also be scrollable, and further navigable (or scrollable) through extended lists and data organizational trees. In implementations, a selectable feature is provided (such as new task/reorder button 408 in FIG. 4A) to enable a user to interact with tasks. The button is selectable to provide task-associated interactions, such as to add new tasks or to reorder existing tasks in the interface.

The embodiment of FIG. 4B illustrates a menu of potential actions which may be created for the task 460 “blog to market expertise.” After an action 470 is selected from the menu, a user provides an input to be associated with the new action to be created. A container record and header is created for the new action. The list of available actions in the menu of FIG. 4B include adding a note, adding an event/date, adding a contact, adding an income/sale description, adding an expense/purchase description, or adding photo/video/audio media. The menu of FIG. 4B also enables adding a new task (“To-Do”) associated with a quest as well. A selection bar is provided at the bottom enabling quick access for accessing components as described regarding FIGS. 1 and 2.

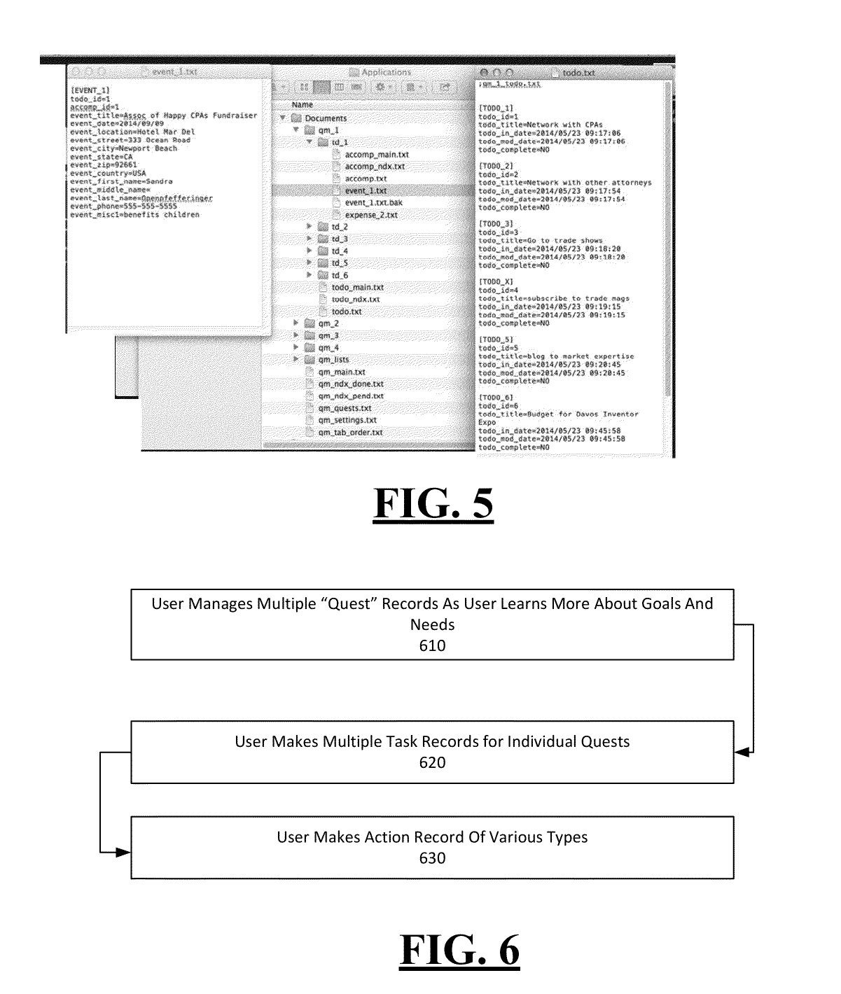

FIG. 5 illustrates an example data structure for storing task-related information. Container records are illustrated as regarding FIG. 1, such as records for actions (e.g. “accomp_main.txt”) and records for tasks (“todo_ndx.txt”). Furthermore, container records for actions (e.g. “event_{—}1.txt”) are associated with tasks (e.g. “todo_id=1”). Data in a task record (e.g. “to-do.txt”) stores information such as the ID of the task, historical information such as when the task was created, title information, and completion status. A data structure as described in FIG. 5 may be used with the embodiments of FIG. 1-4 to store container records.

FIG. 6 illustrates an example method in which a user develops and updates one or more quest records, according to an embodiment. An example such as described by FIG. 6 can be implemented using components such as described with FIG. 1 or FIG. 2. An example of FIG. 6 illustrates actions available to the user including, with reference to elements of FIG. 1, actions involving quest records 151, task records 153, and action records 155. As described, a user can view a plurality of action records of a selected type and to obtain information content and emotional and motivational support.

In some implementations, an example of FIG. 6 can be implemented by executing an application (e.g., “app”) on a computing device. The “app” can operate as, for example, a standalone network based application or enterprise style application.

In more detail, a user can manage multiple quest records as a user learns more about goals and needs (610). For each quest, the user can make and manage multiple task records for each quest (620). Additionally, the user can make and manage multiple action records of different types for each quest record (630). With reference to an example of FIG. 2, the processor 202 can generate the user interface 222 so that from a given interface, the user can view the plurality of quest records at one time. Furthermore, from any given interface of the application on which an example of FIG. 6 is implemented, some or all of the action records of a selected type can be viewed independent of the quest record. Thus, the actions can be viewed independent of quest records. In some variations, the view of individual action records of a single type can identify the quest and task records associated with that action. In addition, the single type view can incorporate visual cues for ease of use, such as color coding event dates, for nearness to the current date.

Still further, a user can operate the application to view the plurality of tasks associated with a particular quest record and the plurality of all action records associated with a particular task, with each action record having a color-coding and written identification as to type for ease of use.

Moreover, at any point, the user can request and obtain information content and emotional or motivational support.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for enabling a user to manage tasks, the method being performed by one or more processors, comprising:
receiving a first user input that defines a first task;
enabling the user to create a plurality of entries associated with the first task, each of the plurality of entries specifying an action record that has a type selected from a group of types that includes a contact type and a calendar type;
displaying a heading for the first task that is in-line with an active interface feature;
upon selection of the active interface feature, performing at least one of:
(A) providing, with the interface, one or more editing features to enable the user to (i) create a new entry and select a type for the new entry, (ii) edit an existing entry, and/or (iii) delete and existing entry, and/or (iv) re-order entries; and/or
(B) displaying an interface that includes the plurality of entries.

2. The method of claim 1, wherein the plurality of entries includes a view that is captured when the user selects the active interface feature so that the plurality of entries are displayed.

3. The method of claim 2, wherein the view corresponds to a list of the plurality of entries.

4. The method of claim 2, wherein the view provides one or more distinguishing features delineating the type of the action.

5. The method of claim 4, wherein the one or more distinguishing features includes color-coded header data which is provided with each displayed entry.

6. The method of claim 1, further comprising providing a group mode selection feature, where upon selection of the group mode selection feature, entries of a particular type associated with multiple tasks are sorted and displayed together.

7. The method of claim 1, wherein the group of types include a note, photo, video, audio, an event, income/sale, or an expense/purchase.

8. The method of claim 7, further comprising providing a selectable element associated with one of the group of types, and further comprising, in response to the selectable element being selected, providing entry-related information for the one of the group of types.

9. The method of claim 8, wherein the one of the group of types is an event, and wherein providing the entry-related information comprises displaying a list of events each having a color-coded background.

10. The method of claim 9, wherein each of the color-coded backgrounds is coded according to a date of the event.

11. The method of claim 8, wherein the one of the group of types that is associated with the selectable element is the contact type, and wherein providing the entry-related information comprises providing a list of contacts.

12. The method of claim 1, further comprising providing an inspirational message and/or image on the display in response to determining that an overall task associated with the task has been completed.

13. A computer system comprising:
a memory that stores instructions; and
one or more processors, which access instructions from the memory to perform operations including:
receiving a first user input that defines a first goal;
enabling a user to create a plurality of tasks associated with that goal;
enabling the user to create a plurality of entries associated with a first task, each of the plurality of entries specifying an action record that has a type selected from a group of types that includes an income/sale type, an expense/purchase type, a photo type, an audio type, a video type, a note type, a contact type and a calendar type;
displaying a heading for the first task that is in-line with an active interface feature; and
upon selection of the active interface feature, performing at least one of:
(A) providing, with the interface, one or more editing features to enable the user to (i) create a new entry and select a type for the new entry, (ii) edit an existing entry, and/or (iii) delete and existing entry, and/or re-order existing entries; and/or
(B) displaying an interface that includes the plurality of entries.

14. The system of claim 13, wherein the plurality of entries includes a view that is captured when the user selects the active interface feature so that the plurality of entries are displayed.

15. The system of claim 14, wherein the view corresponds to a list of the plurality of entries.

16. The system of claim 14, wherein the view provides one or more distinguishing features delineating the type of the action.

17. The system of claim 16, wherein the one or more distinguishing features includes color-coded header data which is provided with each displayed entry.

18. The system of claim 13, wherein the one or more processors further perform operations including providing a group mode selection feature, where upon selection of the group mode selection feature, entries of a particular type associated with multiple tasks are sorted and displayed together.

19. The system of claim 13, wherein the group of types include a note, photo, video, audio, an event, income/sale, or an expense/purchase.

20. A non-transitory computer-readable medium that stores instructions that, when executed by one or more processors, cause the one or more processors to perform operations comprising:
receiving a first user input that defines a first goal;
enabling a user to create a plurality of tasks associated with that goal;
enabling the user to create a plurality of entries associated with a first task, each of the plurality of entries specifying an action record that has a type selected from a group of types that includes an income/sale type, an expense/purchase type, a photo type, an audio type, a video type, a note type, a contact type and a calendar type;
displaying a heading for the first task that is in-line with an active interface feature; and
upon selection of the active interface feature, performing at least one of:
(A) providing, with the interface, one or more editing features to enable the user to (i) create a new entry and select a type for the new entry, (ii) edit an existing entry, and/or (iii) delete and existing entry and/or (iv) re-order existing entries; and/or
(B) displaying an interface that includes the plurality of entries.
